(19) United States
(12) Patent Application Publication
(10) Pub. No.: US 2022/0396046 A1
(43) Pub. Date: Dec. 15, 2022

(54) FOOD WASTE DISPOSAL APPARATUS

(71) Applicant: BOGANGST Co.,Ltd., Seongnam-si (KR)

(72) Inventor: Jung Hoon JANG, Goyang-si (KR)

(73) Assignee: BOGANGST Co.,Ltd.

(21) Appl. No.: 17/345,590

(22) Filed: Jun. 11, 2021

(51) Int. Cl. B30B 9/12; B09B 3/00; B30B 9/14

(52) U.S. Cl. CPC B30B 9/125; B09B 3/00; B30B 9/14; B30B 9/121

(57) ABSTRACT

Proposed is a food-waste disposal apparatus, in particular, including a transfer housing; a transfer screw rotatably mounted to an inside of the transfer housing, and transferring food waste, which is introduced into the transfer housing, in a frontward direction of the transfer housing while compressing the food waste; and a gap forming portion provided in a rear end portion of the transfer screw, and forming a wastewater discharging gap between a front surface thereof and a rear cross-section of the transfer housing to discharge wastewater coming out of the food waste. Thus, the gap forming portion is provided outside the transfer housing (i.e., outside the rear end portion) and adjustable forward and backward, thereby not only making it easy to adjust a wastewater discharging gap but also discharging the waste water smoothly as a wastewater outlet is oriented downward.

### BACKGROUND

### Field

The disclosure relates to a food-waste disposal apparatus, and more particularly to a food-waste disposal apparatus, in which a gap forming portion is provided outside a transfer housing so as to easily adjust a wastewater discharging gap, and a rotary scraper provided on the back of the gap forming portion prevents dregs of food waste from being piled up or adhered and moves the dregs of food waste in order to efficiently use a wastewater collecting space and secure a discharging channel.

### Description of the Related Art

In general, a certain amount of food waste is thrown out daily at homes, restaurants, etc. and most of such food waste contains a lot of water. Therefore, there is a problem that disposal of the food waste without treatment leads to soil pollution and river pollution.

To solve this problem, there have conventionally been proposed a dehydration apparatus for removing only water from the food waste, technology of using a heater to remove water after microbial decomposition and agitation, etc., and there has recently been proposed a food-waste disposal apparatus that is connected to a sink drain of the home or restaurant, grinds dregs of food waste, and dehydrates and dries the ground food waste.

For example, Korean Patent No. 10-1760110, titled “APPARATUS FOR TREATING FOOD WASTE”, has been disclosed as shown in FIG. 1, in which food waste is introduced into and crushed by a crusher 190 through an upper cover communicating with a sink drain, pressed and moved forward by a lower transfer screw 120, and dried after being discharged to the front of a transfer housing 110.

Here, the dregs of food waste are discharged together with wastewater while being compressed by the transfer screw 120. According to this related art, to minimize the dregs of food waste, a gap forming portion 130 is formed in a rear end portion of the transfer screw 111, thereby discharging the wastewater through a gap from an inner bottom of a collection housing 113.

However, the related art has problems that capacity for discharging the wastewater is low due to a small wastewater discharging gap G and it is very difficult to adjust the size of the gap because the gap is formed at a blade end of the transfer screw. Therefore, it is hard for the transfer screw to compress the food waste, and thus the apparatus is likely to be damaged by overload.

Further, it becomes difficult to discharge the wastewater as the apparatus is used for a long time because the dregs of food waste and grease stick together in the small gap, and a wastewater outlet gets clogged by the dregs of food waste piled or adhered in the wastewater collecting space, thereby causing problems of degrading performance, smelling bad, etc.

### SUMMARY

An aspect of the disclosure is to provide a food-waste disposal apparatus, in which a gap forming portion is provided outside a transfer housing (outside a rear end portion) and adjustable forward and backward, thereby not only making it easy to adjust a wastewater discharging gap but also discharging the waste water smoothly as a wastewater outlet is oriented downward

Further, another aspect of the disclosure is to provide a food-waste disposal apparatus, in which a rotary scraper not only prevents dregs of food waste from being piled up or adhered to a rear cover but also moves the dregs of food waste forward, thereby efficiently using a wastewater collecting space and easily discharging the dregs of food waste through the wastewater outlet.

Further, still another aspect of the disclosure is to provide a food-waste disposal apparatus, in which a wastewater discharging gap is varied in size depending on its position, thereby maximizing a discharging amount of waste water, and making it possible to discharge dregs of food waste different in size according to the positions of the gap without changing a gap forming portion.

In accordance with an embodiment of the disclosure, there is provided a food-waste disposal apparatus including: a transfer housing; a transfer screw rotatably mounted to an inside of the transfer housing, and transferring food waste, which is introduced into the transfer housing, in a frontward direction of the transfer housing while compressing the food waste; and a gap forming portion provided in a rear end portion of the transfer screw, and forming a wastewater discharging gap between a front surface thereof and a rear cross-section of the transfer housing to discharge wastewater coming out of the food waste.

Here, the food-waste disposal further include a collection housing communicating with a back side of the transfer housing and including a wastewater collecting space in which wastewater discharged through the wastewater discharging gap is collected, wherein the gap forming portion is shaped like a plate having an area and size to cover a rear end of the transfer housing.

The gap forming portion may be provided to have various plate shapes such as a circular plate, a polygonal plate, etc. as long as it prevents the wastewater or the dregs of food waste from being discharged to no other spaces than the wastewater discharging gap. However, the gap forming portion is not limited to the plate shape, but may be variously shaped like a rod, a sphere, etc. thicker than a predetermined thickness

The gap forming portion may be rotatable along with rotation of the transfer screw. However, the gap forming portion does not have to be rotatable simultaneously with the rotation of the transfer screw. For example, the gap forming portion may not be rotatable, or may be rotatable at different speed from that of the transfer screw.

The gap forming portion may include a rotary scraper provided on a back thereof and radially protruding having a set width and a set length, and the collection housing includes a lower inner surface having a circular shape corresponding to a turning radius of an end portion of the rotary scraper, so that the rotary scraper can scrape the lower inner surface of the collection housing to prevent dregs of wastewater from being piled up or adhered while turning as the gap forming portion rotates.

The inner surface of the collection housing does not have to be entirely shaped corresponding to the turning radius of the rotary scraper, but may partially have a circular shape corresponding to a partial section of a lower portion to which a lot of dregs of food waste are adhered or piled up.

The rotary scraper may include a soft or resilient material, or the end portion of the rotary scraper may include a soft or resilient material at one side thereof.

To effectively scrape the dregs of food waste off the inner surface of the collection housing, the end portion of the rotary scraper needs to have no gap or be in close contact with the inner surface of the collection housing while turning, and thus damage or noise may occur. Therefore, silicon or the like soft or resilient material is attached to the end portion of the rotary scraper, or the whole rotary scraper is made of a soft or resilient material, thereby rotating as if to sweep the inner surface of the collection housing.

The rotary scraper may be inclined to move the drags of wastewater in a frontward direction of the collection housing. The inclined direction of the rotary scraper may be formed so that a normal to the plate of the gap forming portion can be angled other than 90 degrees to a normal to the plate of the rotary scraper, or one or two of the normals can be inclined in a direction where the rotary scraper turns left and right under the condition that the two normals are perpendicular to each other.

The collection housing may include a wastewater outlet at a lower side thereof to discharge out wastewater stored in the wastewater collecting space, and the turning radius of the rotary scraper may cover a part or the whole of the wastewater outlet so that the rotary scraper can prevent the wastewater outlet from being clogged by dregs of wastewater.

The rotary scraper may include a single rotary scraper or a plurality of rotary scrapers, and may be formed integrally with the gap forming portion or separately manufactured to be fastened or detachably coupled.

In the foregoing embodiments, the gap forming portion is movable along a rotary axial line of the transfer screw, and adjusts the size of the wastewater discharging gap.

The transfer housing may include rear cross-sections different in protruding length, so that the wastewater discharging gap can be varied depending on positions.

### BRIEF DESCRIPTION OF THE DRAWINGS

The above and/or other aspects will become apparent and more readily appreciated from the following description of embodiments, taken in conjunction with the accompanying drawings, in which:

FIG. 1 illustrates a conventional food-waste disposal apparatus;

FIG. 2 is an exploded perspective view of a food-waste disposal apparatus according to an embodiment of the disclosure;

FIG. 3 shows a cross-sectional view and a partially enlarged view of a food-waste disposal apparatus according to an embodiment of the disclosure;

FIG. 4 is a perspective view of a transfer screw and a gap forming portion according to an embodiment of the disclosure;

FIGS. 5A-5E illustrate a gap forming portion and a rotary scraper according to various embodiments of the disclosure;

FIGS. 6 and 7 are perspective views of a transfer housing and a collection housing according to an embodiment of the disclosure; and

FIG. 8 is a perspective view of a rear cover according to an embodiment of the disclosure.

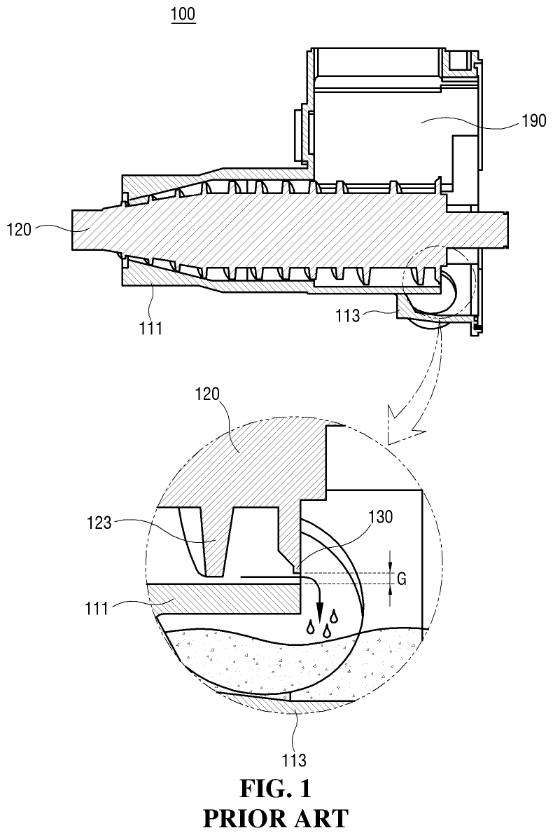

### DETAILED DESCRIPTION OF EMBODIMENTS

Below, the disclosure will be described in detail with reference to the accompanying drawings.

Prior to description, the disclosure is not limited or restricted to embodiments set forth herein, and like numerals refer to like elements throughout so that descriptions can be made by referring to the elements shown in the other drawings. Further, descriptions obvious to those skilled in the art or repetitive descriptions may be omitted.

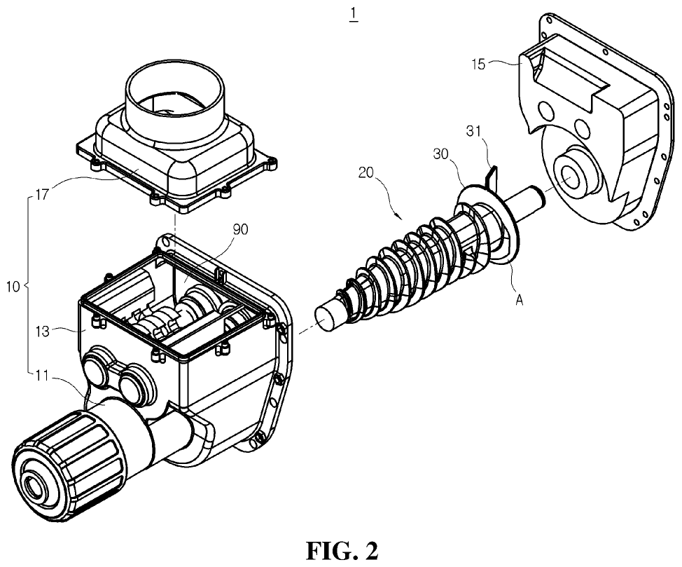

Referring to FIG. 2, a food-waste disposal apparatus 1 according to an embodiment of the disclosure includes a transfer housing 11, a transfer screw 20, and a gap forming portion 30 provided in a rear end portion of the transfer screw 20 and forming a wastewater discharging gap G between its front surface and a rear cross-section 133 of the transfer housing 11.

A housing 10 may include the transfer housing 11, a collection housing 13, a rear cover 15 and an upper cover 17.

The transfer housing 11 is provided in front of the collection housing 13 and communicates with the collection housing 13, and the rear cover 15 is mounted with a driver (not shown) for driving the transfer screw 20 and a crusher 90. The upper cover 17 is coupled to the collection housing 13 in a downward direction, and an upper opening is connected to a food waste inlet of a sink (not shown).

Thus, food waste put into the upper cover 17 is finely crushed through the crusher 90, transferred frontward while being compressed through the transfer screw 20 at a lower end, and collected in a food-waste collection box through a front-end opening of the transfer housing 11.

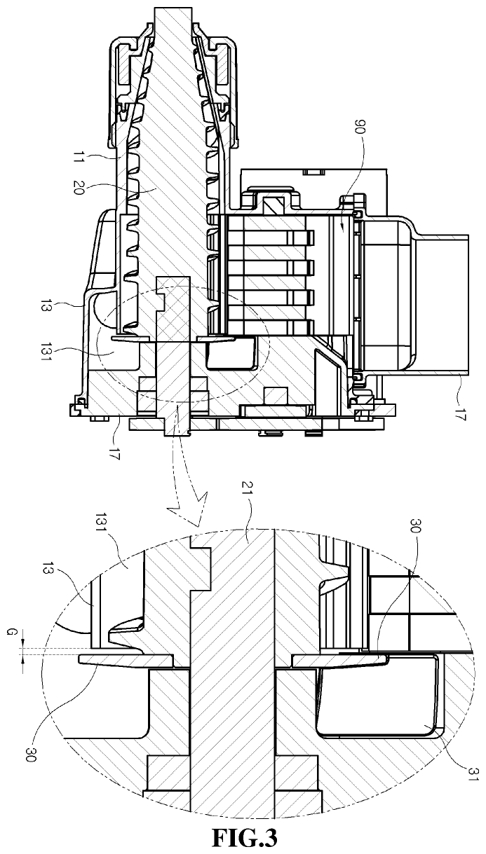

Here, wastewater comes out while the food waste crushed inside the transfer housing 11 is compressed by a blade 23 of the transfer screw 20. As shown in FIG. 3, the wastewater flows toward the rear end of the transfer housing 11 via an inner bottom of the transfer housing 11.

The collection housing 13 communicates with the back side of the transfer housing 11, and is formed with a wastewater collecting space 131 in which the wastewater discharged through the wastewater discharging gap G is collected.

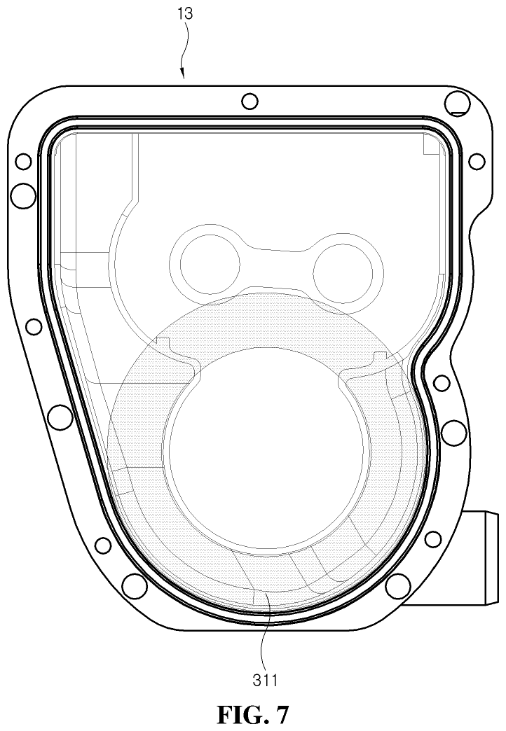

FIG. 6 illustrates the inner spaces of the transfer housing 11 and the collection housing 13. The wastewater coming out during a compression process of the food waste is mixed with the finely crushed dregs of food waste besides pure water. The collection housing 13 includes the wastewater collecting space 131 in which such dregs of food waste and wastewater are temporarily collected, and a wastewater outlet 135 at a lower side thereof to discharge the collected wastewater to the outside.

The transfer screw 20 is rotatably mounted to the inside of the transfer housing 11, and makes the food waste introduced into the transfer housing 11 be compressed and transferred in a front direction of the transfer housing 11

For example, as shown in FIG. 4, the transfer screw 20 includes a rotary shaft for rotating the transfer screw 20 with rotary power received from the driver, and a blade 23 formed on an outer circumference of the transfer screw 20 and compressing and transferring the food waste. Here, the shape and number of blades 23 may be varied.

The gap forming portion 30 is provided in the rear end portion of the transfer screw 20, and forms the wastewater discharging gap G (see the enlarged view of FIG. 3) between its front surface (in a direction toward the transfer housing, see “A” in FIG. 2) and a rear cross-section 133 (see a hatched portion in FIG. 6) of the transfer housing 11 and discharging the wastewater coming out of the food waste.

Therefore, the food-waste disposal apparatus according to the disclosure has advantages that the wastewater is smoothly discharged because the wastewater discharging gap is oriented in a downward direction where the wastewater outlet is positioned, and the size of the gap is easily adjustable by adjusting the position of the gap forming portion forward and backward.

The gap forming portion 30 may have various sizes and shapes, but the area and size thereof are required to cover the rear end of the transfer housing 11.

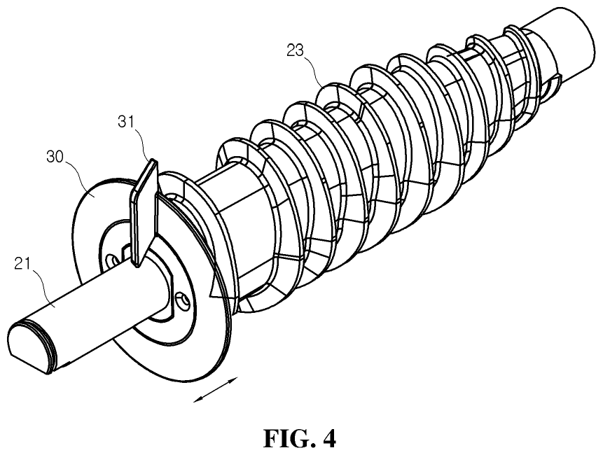

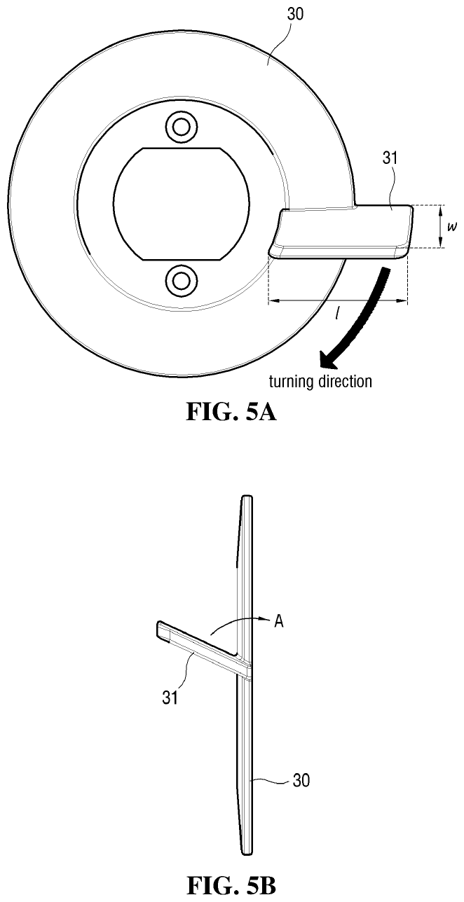

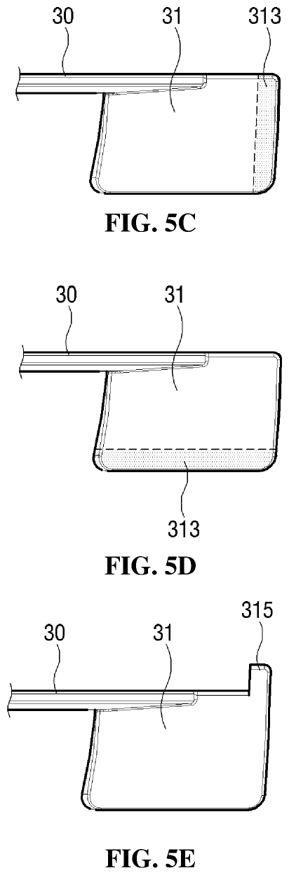

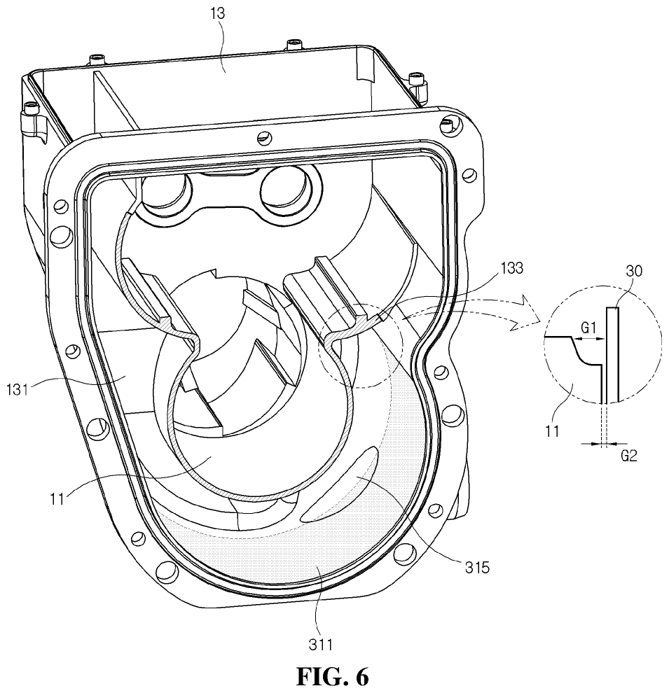

In other words, the gap forming portion 30 is provided to have a size for covering the rear-end opening of the transfer housing 11 and shaped like not only a circular plate as shown in FIG. 4 or FIGS. 5A-5E but also a polygonal plate such as a quadrangular plate as long as it prevents the wastewater and the dregs of food waste from being discharged to no other spaces than the wastewater discharging gap G.

The gap forming portion 30 is provided to be rotatable along with the rotation of the transfer screw 20.

The gap forming portion 30 and the transfer screw 20 may be provided as a single body, but may be separately provided to be fastened or detachably coupled.

In the latter case, the gap forming portion 30 may be fastened to the transfer screw 20 and rotatable together. Although the gap forming portion 30 is not rotatable, there are no problems in forming the wastewater discharging gap G and discharging the wastewater.

Referring to FIGS. 4 and 5A-5E, a rotary scraper 31 may be provided on the back of the gap forming portion 30 and radially protruding with set width w and length l.

The width w and length l of the rotary scraper 31 may be varied. Preferably, the width w may be provided to correspond to the space between the gap forming portion 30 and the rear cover 15, and the length l may be provided so that the end portion of the rotary scraper 31 can almost reach the lower inner surface of the collection housing 13 as shown in FIG. 7.

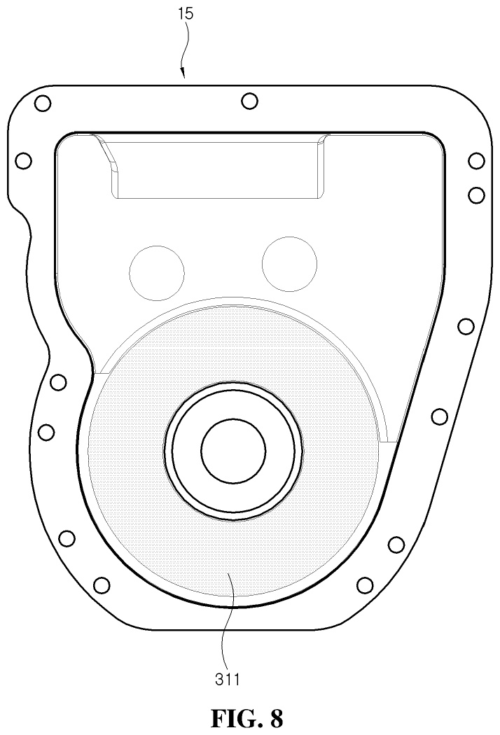

FIG. 7 illustrates a turning radius of the rotary scraper 31, in which the lower inner surface of the collection housing 13 has a circular shape corresponding to the turning radius of the end of the rotary scraper 31. In this case, the gap between the end portion of the rotary scraper 31 and the lower inner surface of the collection housing 13 is variously adjustable as necessary. Meanwhile, as shown in FIG. 8, the rear cover 15 is provided to have a shape corresponding to the turning region of the rotary scraper 31 so that the rotary scraper 31 can be turned.

Thus, as the gap forming portion 30 rotates, the rotary scraper 31 turns and scrapes the lower inner surface of the collection housing 13, thereby preventing the dregs of wastewater from being piled up or adhered.

Meanwhile, the rotary scraper 31 may be inclined to move the dregs of wastewater in a frontward direction of the collection housing 13.

In FIG. 5A shows that the rotary scraper 31 is positioned in the 3 o'clock position by the rotated gap forming portion 30, and FIG. 5B shows that the rotary scraper 31 is positioned in the 9 o'clock position by the rotated gap forming portion 30.

In other words, the dregs of food waste piled up between the gap forming portion 30 and the rear cover 15 move along an inclined surface A of the rotary scraper 31 in a frontward direction in which the wastewater outlet 135 is formed, when the rotary scraper 31 turns (as shown in FIGS. 5A-5E, there is a room for allowing the dregs of food waste to move because the rotary scraper 31 protrudes outward beyond the gap forming portion 30).

Therefore, in the food-waste disposal apparatus according to the disclosure, the rotary scraper not only prevents the dregs of food waste from being piled up or adhered to the rear cover, but also moves the dregs of food waste forward, thereby having advantages of not only efficiently using the wastewater collecting space but also easily discharging the dregs of food waste to the wastewater outlet.

Meanwhile, the rotary scraper 31 may be made of a soft or resilient material. Alternatively, an end portion of the rotary scraper 31 may be made of a soft or resilient material. Alternatively, a soft or resilient material may be attached to an end portion of the rotary scraper 31.

Thus, friction or collision between the end portion of the rotary scraper 31 and the inner surface of the collection housing 13 is minimized to thereby prevent damage due to the friction or collision. Further, the soft or resilient material allows the rotary scraper 31 to be rotatable while scraping the inner surface of the collection housing 13, thereby having advantages of readily scraping off and transferring the dregs of food waste.

In a lower side of the collection housing 13, the wastewater outlet 135 is provided to discharge the wastewater stored in the wastewater collecting space 131 to the outside.

In this case, as shown in FIG. 6, a turning radius 311 of the rotary scraper 31 is provided to cover a part or the whole of the wastewater outlet 135, so that the rotary scraper 31 can prevent the wastewater outlet 135 from being clogged with the dregs of wastewater.

To this end, as shown in FIG. 5E, the rotary scraper 31 may additionally include an extended portion 315 formed at an end portion thereof. The extended portion 315 may have various shapes.

The number of rotary scrapers 31 may be varied. As shown in FIGS. 5A-5E, a single rotary scraper may be provided. Alternatively, two or more rotary scrapers or a plurality of rotary scrappers may be provided. Here, the rotary scraper 31 and the gap forming portion 30 may be formed as a single body, or may be separately manufactured to be fastened or detachably coupled to each other.

In the foregoing embodiments, the gap forming portion 30 is movable along a rotary axial line of the transfer screw 20 so that the size of the wastewater discharging gap G can be adjusted.

In other words, as shown in FIG. 4, when the gap forming portion 30 is separately manufactured and then coupled to the transfer screw 20, the coupling position is movable in the arrow direction to thereby easily adjust the wastewater discharging gap G.

Meanwhile, the rear cross-section 133 of the transfer housing 11 is provided to have different protruding lengths, so that the wastewater discharging gap G can be varied depending on positions.

In other words, according to the foregoing embodiments, as shown in the enlarged view of FIG. 3 and FIG. 6, the front surface of the gap forming portion 30 is in parallel with the rear cross-section 133 of the transfer housing 11, and thus the wastewater discharging gap G is uniform at all the positions of the rear cross-section 133 shown in FIG. 6. However, as shown in the enlarged view of FIG. 6, the protruding length of the rear cross-section 133 of the transfer housing 11 may be changed to have a wide wastewater discharging gap G1 or a narrow wastewater discharging gap G2 according to the positions of the rear cross-section 133.

The protruding length of the rear cross-section 133 may be formed by a plurality of grooves or the like shapes throughout the whole section, or may be widely formed throughout a specific section. For example, the wastewater discharging gap G may be narrowed because the dregs of food waste are more likely to be simultaneously discharged to the lower side of the transfer housing 11, and the wastewater discharging gap G may be widened because relatively large dregs of food waste are less likely to be discharged to the upper side of the transfer housing 11.

Therefore, in the food-waste disposal apparatus according to the disclosure, the wastewater discharging gap is varied in size depending on the positions thereof, thereby having advantages of maximizing a discharging amount of wastewater, and making it possible to discharge dregs of food waste different in size according to the positions of the gap without changing the gap forming portion.

Therefore, in the food-waste disposal apparatus according to the disclosure, the gap forming portion is provided outside the transfer housing (i.e., outside the rear end portion) and adjustable forward and backward, thereby not only making it easy to adjust a wastewater discharging gap but also discharging the waste water smoothly as a wastewater outlet is oriented downward.

Further, in the food-waste disposal apparatus according to the disclosure, the rotary scraper not only prevents dregs of food waste from being piled up or adhered to a rear cover but also moves the dregs of food waste forward, thereby efficiently using the wastewater collecting space and easily discharging the dregs of food waste through the wastewater outlet.

Further, in the food-waste disposal apparatus according to the disclosure, the wastewater discharging gap is varied in size depending on its position, thereby maximizing a discharging amount of waste water, and making it possible to discharge the dregs of food waste different in size according to the positions of the gap without changing the gap forming portion.

Although a few embodiments have been shown and described, it will be appreciated by those skilled in the art that various changes and modifications can be made in these embodiments without departing from the principles and spirit of the invention, the scope of which is defined in the appended claims and their equivalents.

What is claimed is:

1. A food-waste disposal apparatus comprising:
a transfer housing;
a transfer screw rotatably mounted to an inside of the transfer housing, and transferring food waste, which is introduced into the transfer housing, in a frontward direction of the transfer housing while compressing the food waste; and
a gap forming portion provided in a rear end portion of the transfer screw, and forming a wastewater discharging gap between a front surface thereof and a rear cross-section of the transfer housing to discharge wastewater coming out of the food waste.

2. The food-waste disposal apparatus of claim 1, further comprising a collection housing communicating with a back side of the transfer housing and comprising a wastewater collecting space in which wastewater discharged through the wastewater discharging gap is collected,
wherein the gap forming portion is shaped like a plate having an area and size to cover a rear end of the transfer housing.

3. The food-waste disposal apparatus of claim 2, wherein the gap forming portion is rotatable along with rotation of the transfer screw.

4. The food-waste disposal apparatus of claim 3, wherein
the gap forming portion comprises a rotary scraper provided on a back thereof and radially protruding having a set width and a set length,
the collection housing comprises a lower inner surface having a circular shape corresponding to a turning radius of an end portion of the rotary scraper, and
the rotary scraper scrapes the lower inner surface of the collection housing to prevent dregs of wastewater from being piled up or adhered while turning as the gap forming portion rotates.

5. The food-waste disposal apparatus of claim 4, wherein the rotary scraper comprises a soft or resilient material, or the end portion of the rotary scraper comprises a soft or resilient material at one side thereof.

6. The food-waste disposal apparatus of claim 4, wherein the rotary scraper is inclined to move dregs of waste water in a frontward direction of the collection housing.

7. The food-waste disposal apparatus of claim 6, wherein
the collection housing comprises a wastewater outlet at a lower side thereof to discharge out wastewater stored in the wastewater collecting space, and
the turning radius of the rotary scraper covers a part or the whole of the wastewater outlet so that the rotary scraper can prevent the wastewater outlet from being clogged by dregs of wastewater.

8. The food-waste disposal apparatus of claim 4, wherein the rotary scraper comprises a plurality of rotary scrapers.

9. The food-waste disposal apparatus of claim 1, wherein the gap forming portion is movable along a rotary axial line of the transfer screw, and adjusts the size of the wastewater discharging gap.

10. The food-waste disposal apparatus of claim 1, wherein the transfer housing comprises rear cross-sections different in protruding length, so that the wastewater discharging gap can be varied depending on positions.
